(19) United States
(12) Patent Application Publication
(10) Pub. No.: US 2009/0102287 A1
(43) Pub. Date: Apr. 23, 2009

(54) Semiconductor integrated circuit device

(75) Inventor: Hidenari Nakashima, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kanagawa (JP)

(21) Appl. No.: 12/289,197

(22) Filed: Oct. 22, 2008

(30) Foreign Application Priority Data
Oct. 23, 2007 (JP) 275516/2007

(51) Int. Cl. H02J 1/00

(52) U.S. Cl. 307/43

(57) ABSTRACT

Aiming to efficiently preventing an increase in power supply noise caused by a variation in consumption current, a semiconductor integrated circuit device of the present invention includes: first and second power supply interconnections that provide power supply to an internal circuit; a power switch that connects the first power supply interconnection and the second power supply interconnection to each other; power supply noise measurement circuits that measure power supply noise of the internal circuit; and a control circuit that controls a conduction state of the power switch on the basis of a result of a measurement performed by the power supply noise measurement circuits.

### BACKGROUND OF THE INVENTION

1. Field of the Invention

The present invention relates to a semiconductor integrated circuit device, and particularly relates to a semiconductor integrated circuit device in which power supply is controlled by a power switch.

2. Description of the Related Art

Recently, in semiconductor integrated circuit devices, the operation of an internal circuit has been entirely or partially switched according to the using state of the internal circuit (for example, switching between an operation state and a stop state in the internal circuit) in order to reduce power consumption. Moreover, an increasing number of devices use low power supply voltages for the purpose of miniaturizing transistors that constitute the internal circuit and reducing power consumption. In the foregoing semiconductor integrated circuit device, consumption current varies according to the switching of the operation of the internal circuit. When the consumption current varies, noise is generated in a power supply voltage by a resistance component, a capacitor component and an inductance component, which are parasitic on a package of the semiconductor integrated circuit device or the internal circuit thereof. In the recent semiconductor integrated circuit device having the operation power supply voltage made constant, it has become a considerable problem that a false operation occurs in a circuit by a variation in a power supply voltage due to noise.

Accordingly, as a technique for preventing a variation in a power supply voltage, Japanese Patent Translation Publication No. 2005-533471 (hereinafter referred to as Conventional Example 1) discloses a technique for preventing noise in an output voltage in a regulator that outputs voltage such as a power supply voltage. FIG. 15 shows a block diagram of an output regulator 100 disclosed in Conventional Example 1. FIG. 16 is a graph showing a variation in an output voltage Vout of the output regulator 100. The output regulator 100 flows current to a load so that a constant output voltage Vout can be obtained. At this time, in the output regulator 100, the output voltage Vout is fedback to a digital controller 101 through an output sensor 104. Then, the digital controller 101 controls a power stage 102 according to the variation in the output voltage Vout. Moreover, an output from the power stage 102 is adjusted to the output voltage Vout by an output filter 103.

In the output regulator 100, multiple voltage range values (VL1 to VH1, VL2 to VH2, VL3 to VH3 in FIG. 16) are preset in the digital controller 101. Then, the digital controller 101 controls the power stage 102 so that the output voltage Vout can be consequently converged to a voltage value V0, which is in the range from VL1 to VH1, that is, the narrowest range (see FIG. 16). Thereby, the output regulator 101 prevents the variation in the output voltage Vout. This operation corresponds to a general regulator operation.

Further, “Understanding and Minimizing Ground Bounce During Mode Transition of Power Gating Structures”, S. Kim, S. Kosonochy, and D. Knebel. in Int. Symp. Low Power Electronics and Design, August 2003, pp. 22-25 (hereinafter referred to as Conventional Example 2) discloses a method of reducing noise caused by a variation in consumption current. In Conventional Example 2, a conduction state of power gate switches, which supply operation current to an internal circuit (logic circuit), are switched according to a variation in operation current, thereby preventing power supply noise.

However, the technique in Conventional Example 1 is for preventing the variation in the output voltage of the output regulator 100. For this reason, in Conventional Example 1, there is a problem that when the internal circuit is switched from a stop state to an operation state, it is impossible to prevent a variation in a voltage generated in another region.

Further, in Conventional Example 2, the conduction state of power gate switches are switched according to a predetermined order. Thus, for example, there is a problem that when a variation different from the preset variation is generated in the power supply voltage by a variation in a parasitic component in a package, it is impossible to deal with such a variation.

### SUMMARY

The present invention seeks to solve one or more of the above problems, or to improve upon those problems at lease in part.

A first aspect of the present invention is a semiconductor integrated circuit device including: first and second power supply interconnections that provide power supply to an internal circuit; a power switch that connects the first power supply interconnection and the second power supply interconnection to each other; a power supply noise measurement circuit that measures power supply noise of the internal circuit; and a control circuit that controls a conduction state of the power switch on the basis of a result of a measurement performed by the power supply noise measurement circuit.

The semiconductor integrated circuit device of the present invention controls the conduction state of the power switch on the basis of magnitude of power supply noise measured by the power supply noise measurement circuit. This makes it possible for the semiconductor integrated circuit device of the present invention to control the conduction state of the power switch on the basis of magnitude of power supply noise actually generated regardless of a variation in a parasitic component in a package or the like.

According to the semiconductor integrated circuit device of the present invention, it is possible to reduce power supply noise caused by a variation in consumption current regardless of a variation in a parasitic component in a package or the like.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a block diagram of a semiconductor integrated circuit device according to Embodiment 1 of the present invention;

FIG. 2 is a circuit diagram of a power switch according to Embodiment 1;

FIG. 3 is a view showing a current-voltage characteristic of power gate switches according to Embodiment 1;

FIG. 4 is a circuit diagram showing another example of the power switch according to Embodiment 1;

FIG. 5 is a schematic diagram of the semiconductor integrated circuit device according to Embodiment 1;

FIG. 6 is an equivalent circuit diagram of the semiconductor integrated circuit device shown in FIG. 5;

FIG. 7 is a graph showing a simulation result using the equivalent circuit of the semiconductor integrated circuit device shown in FIG. 6;

FIG. 8 is a partially enlarged view of the graph shown in FIG. 7;

FIG. 9 is a flowchart of the semiconductor integrated circuit device according to Embodiment 1;

FIG. 10 is a view showing a relationship between a power supply voltage and an upper-side determination voltage in the semiconductor integrated circuit device according to Embodiment 1;

FIG. 11 is a view showing a relationship between a power supply voltage and a lower-side determination voltage in the semiconductor integrated circuit device according to Embodiment 1;

FIG. 12 is a view showing a relationship between power supply noise and the number of power gate switches being turned on when control is performed in accordance with the flowchart shown in FIG. 10;

FIG. 13 is a view showing an effect appeared when the power switch is controlled according to a result of a measurement performed by a measurement circuit in the semiconductor integrated circuit device according to Embodiment 1;

FIG. 14 is a block diagram of a semiconductor integrated circuit device according to Embodiment 2 of the present invention;

FIG. 15 is a block diagram of an output regulator according to Conventional Example 1; and

FIG. 16 is a view showing a variation in an output voltage in the output regulator according to Conventional Example 1.

### DESCRIPTION OF THE PREFERRED EMBODIMENTS

### Embodiment 1

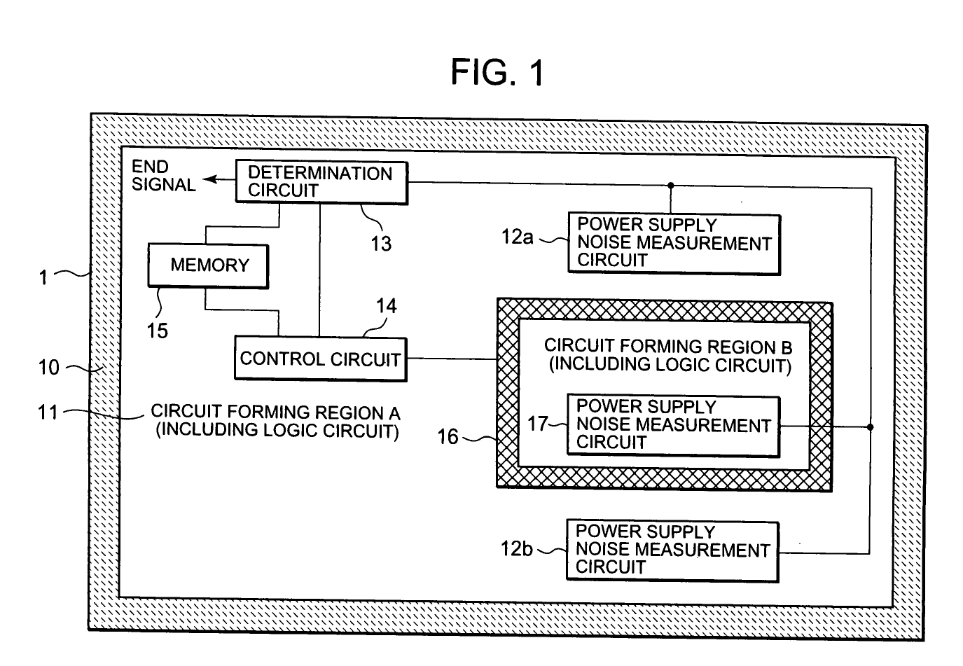

Embodiments of the present invention will be described below with reference to the drawings. FIG. 1 shows a block diagram of a semiconductor integrated circuit device 1 according to this embodiment. As shown in FIG. 1, the semiconductor integrated circuit device 1 has a package 10 and a circuit forming region 11 included in the package 10. The circuit forming region 11 has therein a circuit forming region A and a circuit forming region B. The circuit forming region A includes a logic circuit (not shown) used as an internal circuit, power supply noise measurement circuits 12a, 12b, a determination circuit 13, a control circuit 14 and a memory 15. The circuit forming region B is a region which is formed in part of the circuit forming region A and which has a power switch 16 formed therearound. Moreover, the circuit forming region B includes a logic circuit (not shown) used as an internal circuit and a power supply noise measurement circuit 17. In the following description, it is assumed that the semiconductor integrated circuit device 1 operates on the basis of power supply voltage and ground voltage supplied from outside. Moreover, it is assumed that the internal circuit, which is not shown, is provided as a functional block in the semiconductor integrated circuit device 1.

The power supply noise measurement circuits 12a and 12b measure levels of power supply noise and a power supply voltage in the circuit forming region A. For example, the power supply noise measurement circuits 12a and 12b are arranged, for example, on an upper side of the circuit forming region A, and on a lower side thereof in the drawing, respectively. In other words, the power supply noise measurement circuits 12a and 12b measure a power supply voltage and power supply noise in different portions of the circuit forming region A. The power supply noise measurement circuit 17 measures levels of power supply noise and a power supply voltage in the circuit forming region B.

Although no limitation is particularly imposed on circuits used as the power supply noise measurement circuits 12a, 12b and 17, a measurement circuit as shown in, for example, “Measurement Results of On-chip IR-drop”, K. Kobayashi et al., CUSTOM INTEGRATED CIRCUITS CONFERENCE, 2002, Proceedings of the IEEE 2002, volume, issue, 2002 pp. 521-524 (hereinafter referred to as Non-Patent Document 2) may be used. The measurement circuit disclosed in Non-Patent Document 2 has a level shifter and a flip-flop circuit. The level shifter detects that a power supply voltage is equal to or less than a reference voltage and then the flip-flop circuit measures a time period for which a power supply voltage is equal to or less than a reference voltage. In other words, the measurement circuit disclosed in Non-Patent Document 2 measures a decrease in power supply voltage to thereby measure magnitude in power supply noise.

The memory 15 stores therein a predetermined determination voltage value and a predetermined reference voltage value. The determination circuit 13 compares the determination voltage value and the reference voltage value with the measurement result outputted from each of the power supply noise measurement circuits 12a, 12b and 17. Then, the determination circuit 13 determines whether or not the voltage level of the power supply voltage and the power supply noise are within a predetermined range. Then, the determination circuit 13 outputs a control signal and an end signal on the basis of the determination result. A method for determining a voltage value and a voltage level in the determination circuit will be described later in detail.

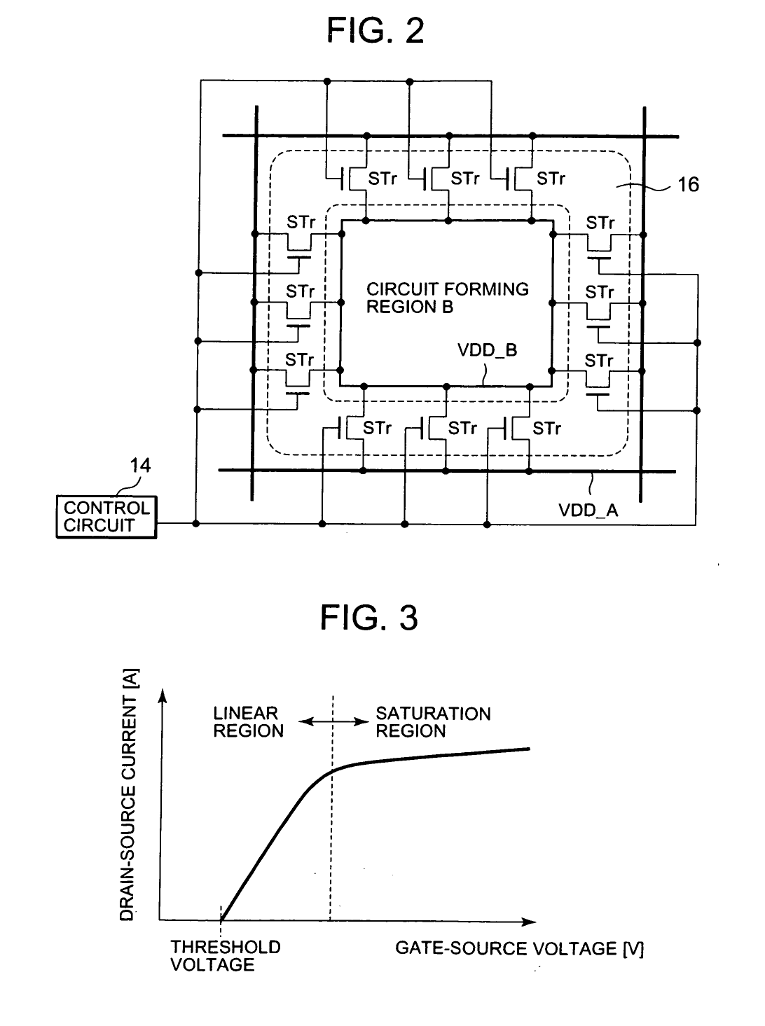

The control circuit 14 controls a conduction state of the power switch 16 on the basis of a control signal outputted from the determination circuit 13. The power switch 16 is formed around the circuit forming region B. Here, a specific configuration of the power switch 16 is shown in FIG. 2. As shown in FIG. 2, in the circuit forming region A, a first power supply interconnection VDD_A is formed in a mesh pattern. The circuit forming region B is formed in one mesh section formed by the first power supply interconnection VDD_A. Moreover, a second power supply interconnection VDD_B is formed around the circuit forming region B. The power switch 16 is formed between the first power supply interconnection VDD_A and the second power supply interconnection VDD_B, and switches connection between two power supply interconnections.

The power switch 16 has multiple power gate switches STr. In an example shown in FIG. 2, three power gate switches STr are formed on each side of the circuit forming region B. Moreover, in the example shown in FIG. 2, gates of the multiple power gate switches STr are connected to the control circuit 14 by common interconnections. In the example shown in FIG. 2, the control circuit 14 controls the conduction state of each power gate switch STr by using a continuous voltage value (hereinafter referred to as an analog voltage value) as a switch control signal. The power gate switch STr is, for example, an NMOS transistor in which a drain-source resistance value is changed by a current value supplied to the gate. In other words, in the power gate switch STr, the current value to be flown between the drain and the source changes according to the voltage value supplied to the gate.

FIG. 3 shows a relationship between a gate-source voltage and drain-source current in an NMOS transistor. As shown in FIG. 3, the NMOS transistor has a linear region operation and a saturation region operation depending on the gate-source voltage. In the linear region, when the gate-source voltage increases and exceeds a threshold voltage, current starts to flow between the drain and the source, and the drain-source current value sharply changes in proportion to magnitude of the gate-source voltage. On the other hand, in the saturation region, even when the gate-source voltage increases, the drain-source current value does not change as sharply as in the linear region. In this embodiment, the analog voltage value to be supplied to the power gate switch STr is caused to change within the range of the linear region to thereby control the current to be flown in the circuit forming region B.

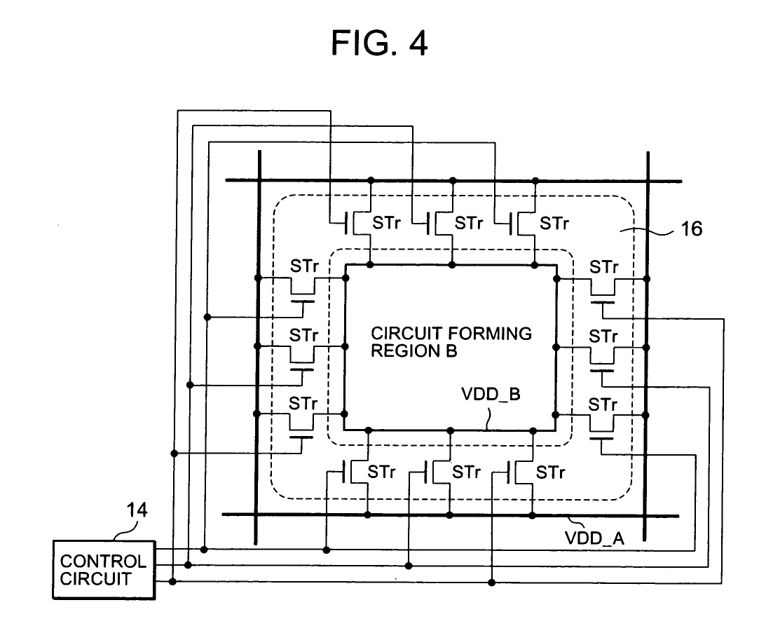

FIG. 4 shows another example of the power switch 16. In the example shown in FIG. 4, the configuration in which the power gate switches STr are connected to the first power supply interconnection VDD_A and the second power supply interconnection VDD_B is the same as that in the example shown in FIG. 2. However, in the example shown in FIG. 4, the control circuit 14 outputs multiple switch control signals. In the example show in FIG. 4, three power gate switches STr are connected to each side of the circuit forming region B, and each switch control signal controls four out of twelve power gate switches STr. Moreover, in the example shown in FIG. 4, the switch control signal is a digital signal, and when the switch control signal is in a low level, the power gate switch STr is in a non-conduction state, and when the switch control signal is in a high level, the power gate switch STr is in a conduction state (an operation in a saturation region).

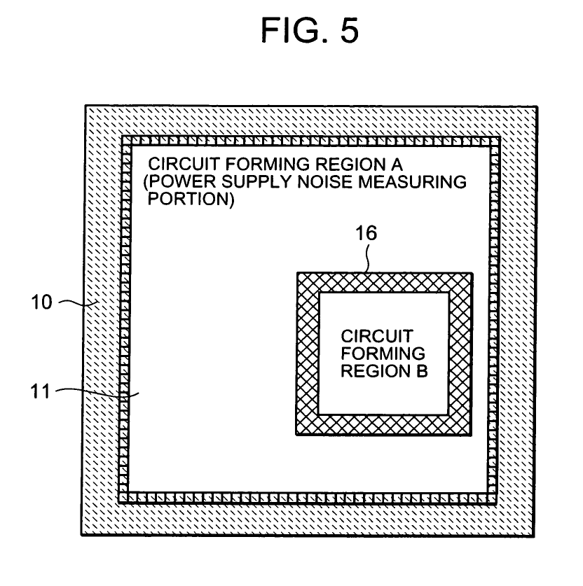

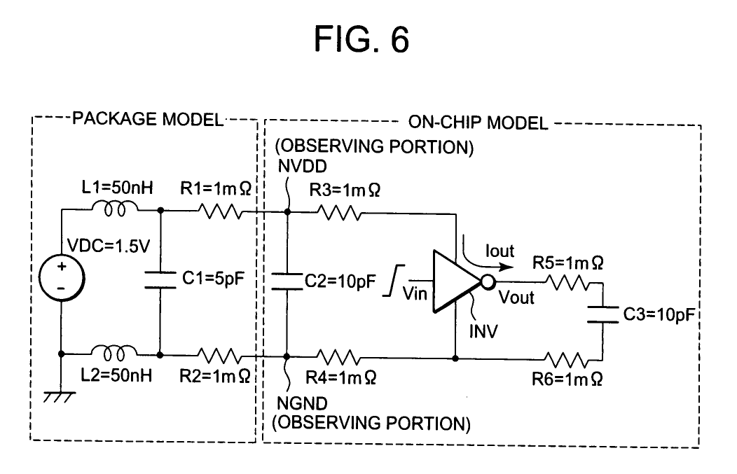

Here, descriptions will be given of power supply noise in the semiconductor integrated circuit device 1. FIG. 5 is a block diagram showing the semiconductor integrated circuit device 1 for explaining power supply noise. In the example shown in FIG. 5, the circuit forming region 11 is stored in the package 10, and the circuit forming region 11 has therein the circuit forming region A and the circuit forming region B. The circuit forming region A is a portion where power supply noise is measured. Moreover, the power switch 16 is formed around the circuit forming region B. FIG. 6 shows an equivalent circuit diagram of the semiconductor integrated circuit device 1 shown in FIG. 5.

As shown in FIG. 6, the semiconductor integrated circuit device 1 shown in FIG. 5 can be expressed by an equivalent circuit including a package model and an on-chip model. The package model includes a power supply VDC, coils L1 and L2, a capacitor C1, and resistors R1 and R2. The power supply VDC has a −terminal connected to a ground interconnection and a +terminal connected to a power supply interconnection. The coil L1 and the resistor R1 are connected to the power supply interconnection in series. The power supply interconnection transmits a power supply voltage to the on-chip model side via the coil L1 and the resistor R1. Meanwhile, the coil L2 and the resistor R2 are connected to the ground interconnection in series. The ground interconnection transmits a ground voltage to the on-chip model side via the coil L2 and the resistor R2. Moreover, the capacitor C1 is connected between the ground interconnection and the power supply interconnection.

The on-chip model has resistors R3 to R6, capacitors C2 and C3, and an inverter INV. The resistor R3 is connected to the power supply interconnection in series and the resistor R4 is connected to the ground interconnection in series. The capacitor C2 is connected between the terminals of the resistors R3 and R4 on the package model side. It should be noted that both ends of the capacitors C2 are portions where a power supply voltage NVDD and a ground voltage NGND are to be measured in a later-described simulation. The inverter INV is connected to terminals opposite to the terminals of the resistors R3 and R4 on the package model side. An output terminal of the inverter INV is connected to one end of the capacitor C3 through the resistor R5. The other end of the capacitor C3 is connected to the ground interconnection through the resistor R6. Here, the inverter INV receives an input signal Vin and outputs an output voltage Vout obtained by inverting the input signal Vin. Further, current, which flows into the capacitor C3 from the power supply interconnection through the inverter INV, is called iout.

Incidentally, the resistor R3 is an equivalent resistance of the power supply interconnection in the circuit forming region A, and the resistor R4 is an equivalent resistance of the ground interconnection in the circuit forming region A. The capacitor C2 is an equivalent capacitor of a circuit formed in the circuit forming region A, and the capacitor C3 is an equivalent capacitor of a circuit formed in the circuit forming region B. The resistors R5 and R6 are equivalent resistors of the power switch 16.

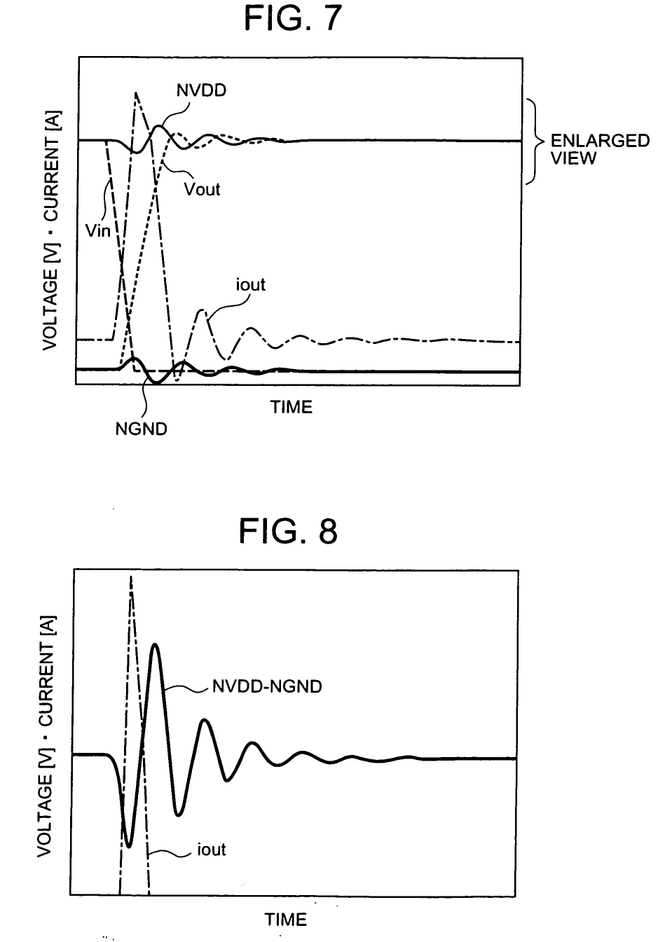

Here, a simulation result using the equivalent circuit illustrated in FIG. 6 will be shown. In this simulation, resistance values of the resistors R1 to R6 are set to 1 mΩ, the capacitance value of the capacitor C1 is set to 5 pF, the capacitance values of the capacitors C2 and C3 are each set to 10 pF, and inductances of the coils L1 and L2 are each set to 55 nH. In addition, an ON/OFF switching of the power switch 16 is performed by the input signal Vin. The waveforms of the simulation result are shown in FIG. 7.

As show in FIG. 7, when the input signal Vin rises and the output signal Vout rises accordingly, the current iout flowing into the capacitor C3 is sharply increased. Then, the current iout is converged to a predetermined current value while its amplitude is attenuated. Further, a sharp change in the current iout generates power supply noise in the power supply voltage NVDD and the ground voltage NGND that are observed at both ends of the capacitor C2. The power supply noise is caused by the resistors R1, R2, coils L1, L2, and the capacitor C1 in the package model. FIG. 8 shows an enlarged view of the waveforms in which attention is focused on a voltage difference between the power supply voltage NVDD and the ground voltage NGND. As shown in FIG. 8, a sharp increase in current iout causes a significant variation in the voltage difference between the power supply voltage NVDD and the ground voltage NGND. In this embodiment, the voltage difference between the power supply voltage NVDD and the ground voltage NGND is measured and the power switch is controlled according to the measurement result, thereby preventing the variation in the voltage difference.

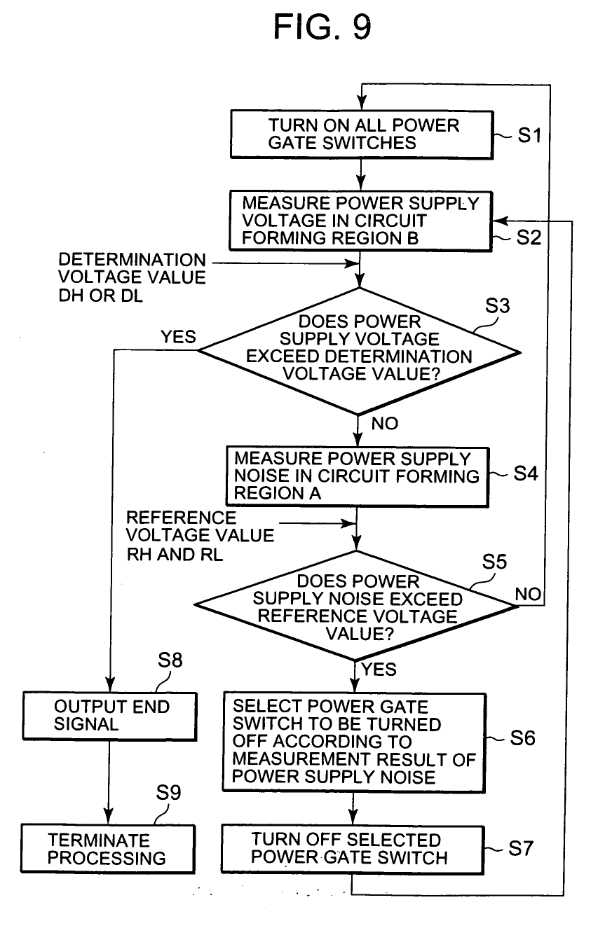

The operation of the semiconductor integrated circuit device 1 will be described below. FIG. 9 is a flowchart showing the operation of the semiconductor integrated circuit device 1. In FIG. 9, it is assumed that the circuit shown in FIG. 4 is used as a power switch. Moreover, the example in FIG. 9 shows a case in which the power switch 16 is switched to be conductive in a state where the power of the circuit forming region A has already been turned on, thereby actuating the circuit in the circuit forming region B.

As shown in FIG. 9, first, the control circuit 14 turns all power gate switches STr of the power switch 16 on (step S1) Thereby, the operation of the circuit in the circuit forming region B is started. Next, the power supply noise measurement circuit 17 measures a power voltage level of the circuit forming region B (step S2). Then, the determination circuit 13 performs comparison between the power supply voltage level measured by the power supply noise measurement circuit 17 and a determination voltage value to determine whether or not the power supply voltage level exceeds the determination voltage value (step S3).

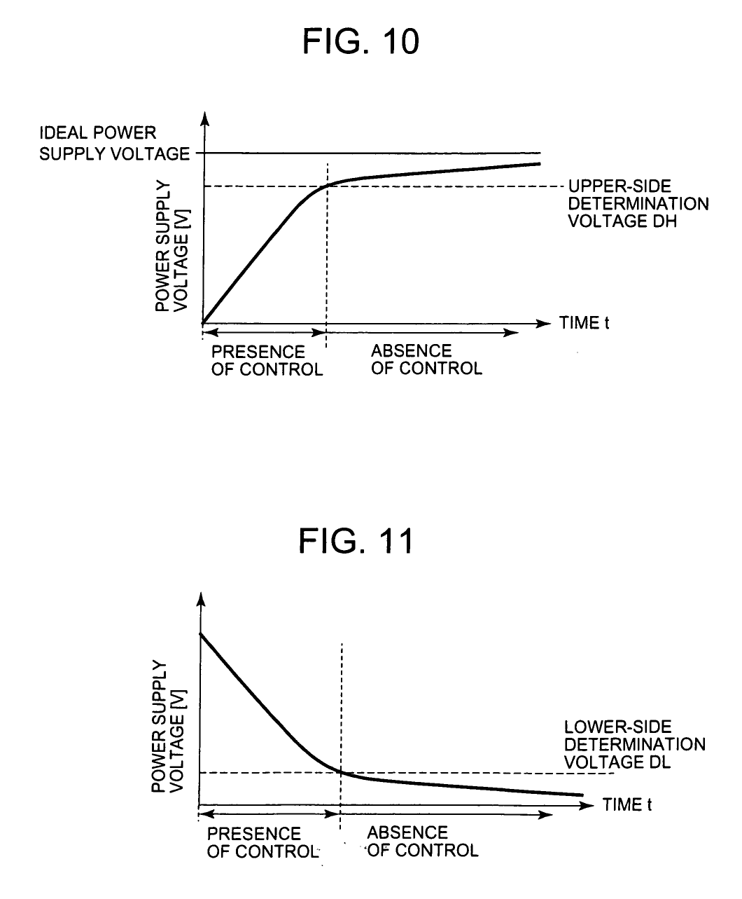

In the determination in step S3, the determination voltage value to be used differs, depending on whether the circuit forming region B is at a stage of shifting from a stop state to a startup state or a stage of shifting from a startup state to a stop state. For example, an upper-side determination voltage value DH is used at the stage of shifting from the stop state to the startup state, and a lower-side determination voltage value DL is used at the stage of shifting from the startup state to the stop state. FIGS. 10 and 11 show a relationship between determination voltage values and a power supply voltage.

FIG. 10 shows a relationship between the upper-side determination voltage value DH and the power supply voltage. As shown FIG. 10, the upper determination voltage value DH is set to a voltage value slightly lower than an ideal power supply voltage that should be originally achieved. Then, the semiconductor integrated circuit device 1 performs the later-described control subsequent to step S3 in FIG. 9, during the time period from when a startup operation for the circuit in the circuit forming region B is initiated to increase the power supply voltage to when the power supply voltage exceeds the upper-side determination voltage. On the other hand, FIG. 11 shows a relationship between the lower-side determination voltage value DL and the power supply voltage. As shown FIG. 11, the lower determination voltage value DL is set to a voltage value slightly higher than an ideal ground voltage that should be originally achieved. Then, the semiconductor integrated circuit device 1 performs the later-described control subsequent to step S3 in FIG. 9, during the time period from when a stop operation for the circuit in the circuit forming region B is initiated to decrease the power supply voltage to when the power supply voltage falls below the lower-side determination voltage.

When the voltage level of the power supply voltage exceeds the determination voltage, the semiconductor integrated circuit device 1 outputs an end signal from the determination circuit 13 (step S8). Further, in an end process, control of the power switch 16 performed by the control circuit 14 is stopped (step S9).

Subsequently, descriptions will be given below of control in a case where the voltage level of the power supply voltage has not yet achieved the determination voltage in step S3 of FIG. 9. In step S4 subsequent to step S3, power supply noise in the circuit forming region A is measured by the power supply noise measurement circuits 12a and 12b. Then, the determination circuit 13 compares magnitude of the power supply noise measured by the power supply noise measurement circuits 12a and 12b with a reference voltage value to determine whether the value of the power supply noise is larger than the determination voltage value (step S5). Here, in this embodiment, the determination voltage value is in a predetermined range including an upper-side reference voltage value RH and a lower-side reference voltage value RL. The upper-side reference voltage value RH and the lower-side reference voltage value RL are set to be in a predetermined range with the original power supply voltage level as a center. In other words, two values of the upper-side reference voltage value RH and the lower-side reference voltage value RL are inputted as the determination voltage values used in step S5.

When the magnitude of the power supply noise is larger than the predetermined range determined on the basis of the determination voltage value, the control circuit 14 selects a power gate switch STr to be turned off according to the magnitude of the power supply noise (step S6). Then, the control circuit 14 turns off the selected power gate switch STr (step S7). Thereby, the resistance value in the power switch 16 increases to thereby reduce current flowing into the circuit forming region B and prevent variations in current in the circuit forming region A, thereby decreasing power supply noise in the circuit forming region A. Then, after completion of the operation in step S7, the operation goes back to step S2 again to measure the power supply level in the circuit forming region B.

On the other hand, in step S5, when the magnitude of the power supply noise is smaller than the predetermined range determined on the basis of the determination voltage value, the operation goes back to step S1, and the control circuit 14 turns all the power gate switches STr on.

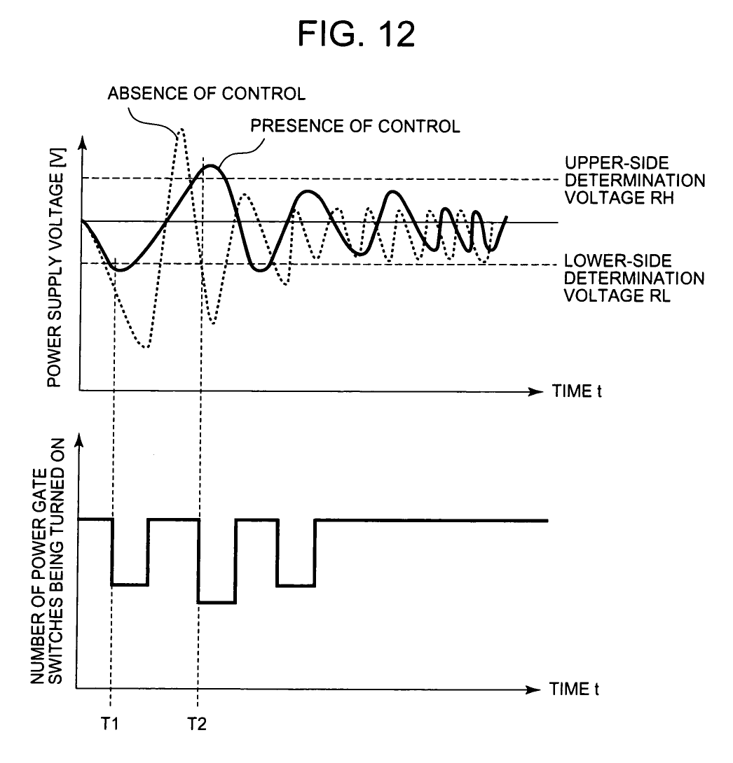

Here, FIG. 12 shows a change in power supply noise when the power switch 16 is controlled in accordance with the flowchart shown in FIG. 9. In FIG. 12, a waveform of the power supply noise is shown in an upper graph and the number of power gate switches STr, which is turned on by performing control, is shown in a lower graph. As shown in FIG. 12, in a state where the operation of the circuit in the circuit forming region B is started, all power gate switches STr are turned on.

Then, when the power supply noise increases and the power supply voltage falls below the lower-side reference voltage value RL, the number of power gate switches STr to be turned on is reduced (timing T1). This increases the resistance value of the power switch 16 to prevent current flowing into the circuit forming region B, thereby avoiding an increase in power supply noise. As shown in FIG. 12, the increase in power supply noise in this embodiment becomes smaller than that in a case where the power switch 16 is not controlled.

Also, when the power supply noise increases and the power supply voltage exceeds the upper-side reference voltage value RH, the number of power gate switches STr to be turned on is reduced (timing T2). This increases the resistance value of the power switch 16 to prevent current flowing into the circuit forming region B, thereby avoiding an increase in power supply noise. As shown in FIG. 12, the increase in power supply noise in this embodiment becomes smaller than that in a case where the power switch 16 is not controlled.

As has been described above, when the circuit in the circuit forming region B to which power is supplied through the power switch 16 operates, the semiconductor integrated circuit device 1 of this embodiment measures magnitude of the power supply noise in the circuit forming region A, and controls the conduction state of the power switch 16 according to the measurement result. Thus, the power switch is controlled on the basis of the measurement result of the power supply noise, thereby preventing the power supply noise regardless of the variation in the parasitic component in the package.

Moreover, in this embodiment, when the voltage level of the power supply voltage in the circuit forming region B exceeds the determination voltage, the determination circuit outputs an end signal. The end signal is transmitted to a logic circuit or the like, which is not shown. In the semiconductor integrated circuit device 1, the circuit formed in the circuit forming region A can grasp the operation state of the circuit formed in the circuit forming region B based on the end signal. By using this end signal, for example, the circuit in the circuit forming region A can determine whether the circuit in the circuit forming region B is operable or not. It should be noted that the end signal may be output when magnitude of the power supply noise is converged to a predetermined range.

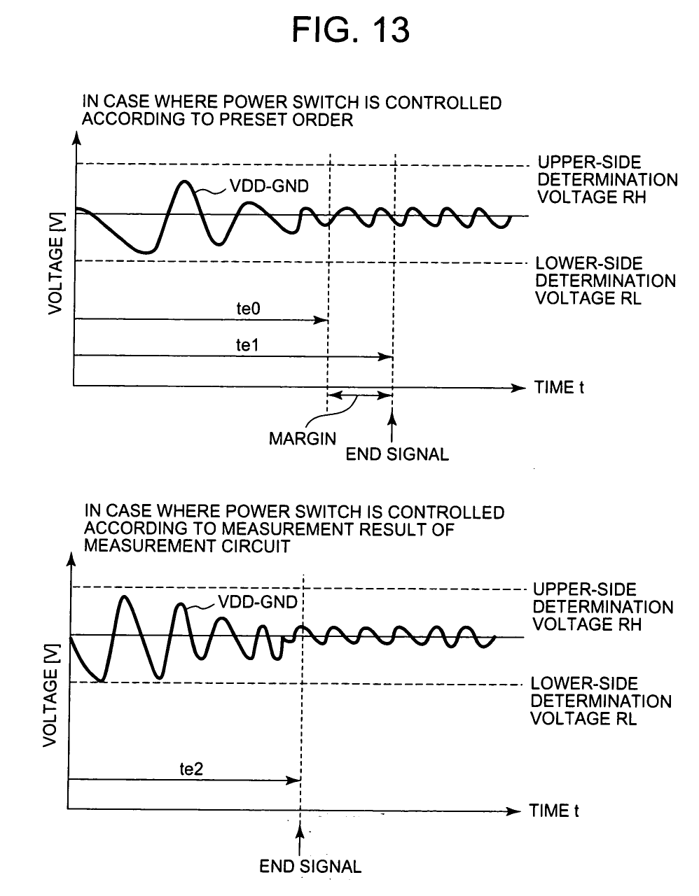

Further, in this embodiment, the end signal can be output according to the measurement result obtained by the measurement circuit, it is possible to advance timing at which the end signal is output. FIG. 13 shows a comparison between a case where the measurement circuit is used and the measurement circuit is not used in connection with timing at which the end signal is output. In the example illustrated in FIG. 13, an upper stage shows an output timing of the end signal when the power switch 16 is controlled according to a preset order, and a lower stage shows an output timing of the end signal when the power switch 16 is controlled according to the measurement result of the measurement circuit.

As shown in FIG. 13, when the power switch 16 is controlled according to the preset order, there is need to provide a predetermined margin with consideration given to the variation in a parasitic component in the package even in a case where the power supply noise is converged when time te0 has actually passed since start of control. Accordingly, in actual, the end signal is output after passage of time te1 that is longer than time te0 at which the power supply noise is converged. On the other hand, when the power switch 16 is controlled according to the measurement result of the measurement circuit (in the case of this embodiment), there is no need to provide the aforementioned margin and the end signal can be output at the same time with convergence of the power supply noise. In other words, the semiconductor integrated circuit device 1 of this embodiment can output the end signal at timing (time te2) earlier than that of the example shown in the upper stage in FIG. 13. FIG. 13 has explained the output timing of the end signal with respect to the magnitude of the power supply noise, but it is possible to advance timing at which the end signal is output even in a case of outputting the end signal with respect to the magnitude of the power supply voltage as in the case of the power supply noise.

### Embodiment 2

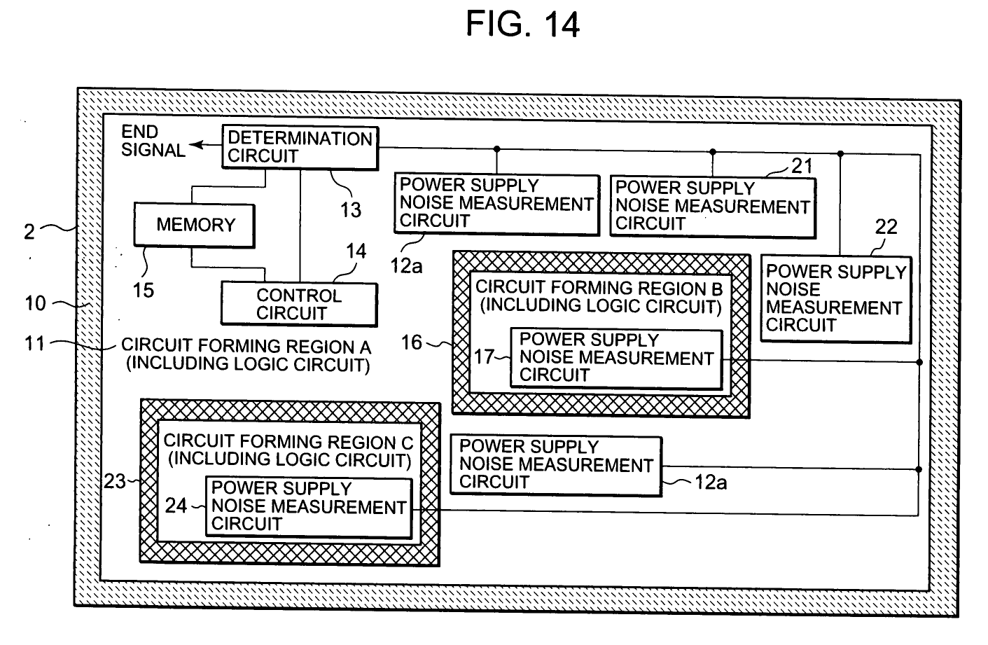

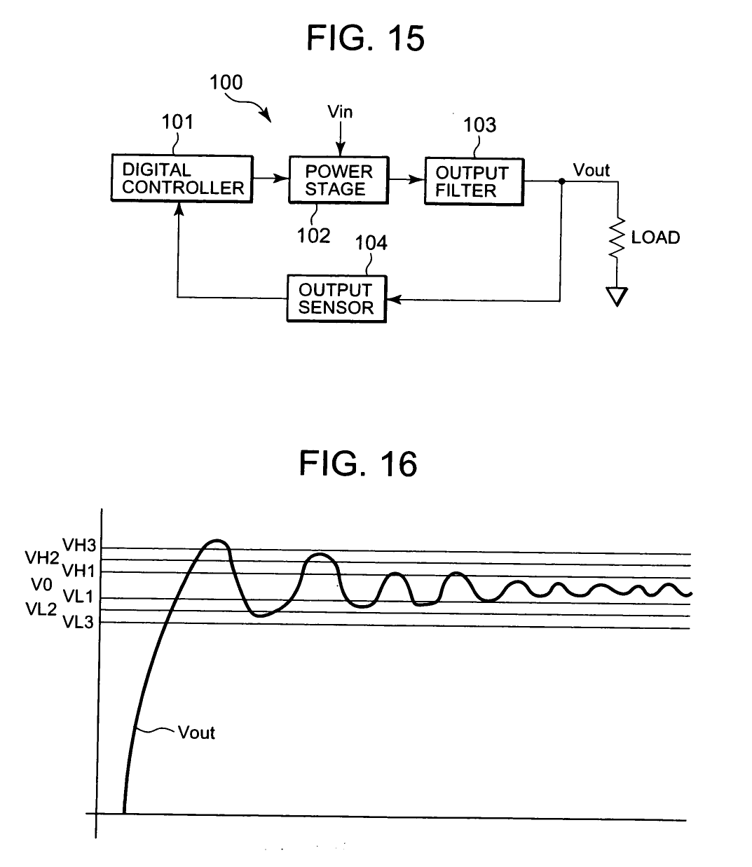

A semiconductor integrated circuit device 2 of Embodiment 2 is one that the semiconductor integrated circuit device 1 is expanded. FIG. 14 shows a block diagram of the semiconductor integrated circuit device 2. As shown in FIG. 14, the semiconductor integrated circuit device 2 includes power supply noise measurement circuits 21, 22, and 24, a power switch 23, and a circuit forming region C, in addition to components of the semiconductor integrated circuit device 1. Herein, the power supply noise measurement circuit 24 is formed in an internal portion of the circuit forming region C, and the power switch 23 is formed around the circuit forming region C. The power supply noise measurement circuits 21 and 22 are the same as the power supply noise measurement circuits 12a and 12b, the power switch 23 is the same as the power switch 16, and the power supply noise measurement circuit 24 is the same as the power supply noise measurement circuit 17.

That is, as compared with the semiconductor integrated circuit device 1, the number of circuit forming regions to which power is supplied by the power switch is increased and the number of measuring points of the power supply noise in the circuit forming region A is increased in the semiconductor integrated circuit device 2 of Embodiment 2. In other words, the present invention is applicable regardless of the number of circuit forming regions to which power is supplied by the power switch. Moreover, the increase in the number of observing points in the circuit forming region A makes it possible to uniformly reduce the power supply noise over the entire circuit forming region.

In addition, the present invention is not limited to the foregoing embodiments and various changes can be appropriately made in the rage without departing from the gist of the present invention. For example, the measurement circuit can be appropriately changed according to the use of the semiconductor integrated circuit device.

What is claimed is:

1. A semiconductor integrated circuit device comprising:
first and second power supply interconnections providing power supply to an internal circuit;
a power switch connecting the first power supply interconnection to the second power supply interconnection;
a power supply noise measurement circuit measuring power supply noises of the internal circuit; and
a control circuit controlling a conduction state of the power switch in accordance with a result of a measurement performed by the power supply noise measurement circuit.

2. The semiconductor integrated circuit device according to claim 1, further comprising
a determination circuit connected between the power supply noise measurement circuit and the control circuit, wherein
the determination circuit compares magnitude of power supply noise in the internal circuit with a predetermined range determined by a reference voltage, and outputs, to the control circuit, a control signal to increase a resistance value of the power switch when the magnitude of the power supply noise exceeds the predetermined range.

3. The semiconductor integrated circuit device according to claim 2, further comprising
a memory storing the reference voltage.

4. The semiconductor integrated circuit device according to claim 2, wherein
the power supply noise measurement circuit further measures a power supply voltage of the power supply, and
the determination circuit outputs an end signal when the power supply voltage satisfies criteria determined by a determination voltage.

5. The semiconductor integrated circuit device according to claim 4, wherein
the determination circuit outputs the end signal and stops control of the power switch performed by the control circuit.

6. The semiconductor integrated circuit device according to claim 4, further comprising
a memory storing the determination voltage.

7. The semiconductor integrated circuit device according to claim 1, wherein
the power switch has a plurality of power gate switches, and
the control circuit controls the plurality of power gate switches by a continuous voltage value.

8. The semiconductor integrated circuit device according to claim 1, wherein
the power switch has a plurality of power gate switches, and
the control circuit controls the number of power gate switches to be turned on among the plurality of power gate switches.
